(19) United States
(12) Patent Application Publication
(10) Pub. No.: US 2024/0186058 A1
(43) Pub. Date: Jun. 6, 2024

(54) COIL FOR A TRANSFORMER ASSEMBLY

(71) Applicant: Hitachi Energy Ltd, Zürich (CH)

(72) Inventors: Antonio Nogues, Zaragoza (ES); Carlos Roy, Zaragoza (ES); Victor Manuel Garcia, Zaragoza (ES); Rafael Murillo, Zaragoza (ES); Lorena Cebrian, Zaragoza (ES); Pilar Morata, Zaragoza (ES); Fernando Munoz, Zaragoza (ES)

(21) Appl. No.: 18/284,837

(22) PCT Filed: Mar. 30, 2022
(86) PCT No.: PCT/EP2022/058494

§ 371 Date: Sep. 28, 2023

(30) Foreign Application Priority Data
Mar. 30, 2021 (EP) 21382260.4

(51) Int. Cl. H01F 27/28; H01R 43/16

(52) U.S. Cl. CPC H01F 27/2852; H01R 43/16; H01F 2027/2857

(57) ABSTRACT

A coil for a transformer assembly is provided. The coil extends circumferentially around a longitudinal axis. The coil comprises a foil winding arrangement and a conductor element. The foil winding arrangement extends circumferentially around the longitudinal axis and has four edge regions. The conductor element covers at least partially at least one of the edge regions of the foil winding arrangement. The conductor element allows for a reduction in an electric field that arises during an operation of the transformer assembly at the edges of the foil winding arrangement. In this manner, a performance improvement in partial discharge tests and lightning impulse tests can be achieved.

### CROSS REFERENCE TO RELATED APPLICATIONS

This application is a 35 U.S.C. § 371 national stage application of PCT International Application No. PCT/EP2022/058494 filed on Mar. 30, 2022, which in turn claims priority to European Patent Application No. 21382260.4, filed on Mar. 30, 2021, the disclosures and content of which are incorporated by reference herein in their entirety.

### FIELD

The present disclosure relates to a coil for a transformer assembly, more particularly, to a coil for a transformer assembly that comprises a foil winding arrangement. The present disclosure further relates to a transformer assembly comprising such a coil.

### BACKGROUND

A transformer is a passive electrical device that transfers electrical energy from one electrical circuit to another, or to multiple circuits. The transformer typically comprises a ferromagnetic core having limbs extending between a first yoke and a second yoke. Coils are wound around the limbs. A varying current in any one of the coils produces a varying magnetic flux in the core, which induces a varying electromotive force across any other coil wound around the core.

A known coil comprises a foil winding arrangement, wherein the foil winding arrangement comprises several turns of a foil wound around the longitudinal axis of the corresponding limb. An “interturn isolation” is provided radially between the turns. The coil may comprise one foil winding arrangement, where the foil has a length along the longitudinal axis that essentially corresponds to the length of the coil. Alternatively, the coil may comprise several groups of foil winding arrangements, wherein each foil winding arrangement forms a “disk”, such that several foil disks are formed, arranged along the longitudinal axis.

The coil further comprises an insulation element, for example made of epoxy resin, surrounding the foil winding arrangement.

Thus, a foil winding arrangement shows, with respect to the longitudinal axis, a first end face and a second end face, wherein the first end face and the second end face extend between a radially inward facing surface of the foil winding arrangement and a radially outward facing surface of the foil winding arrangement, respectively. Typically, the edges formed of those faces of a foil winding arrangement are not electrically screened.

There is a need to provide a coil and a transformer assembly having improved performance features.

### SUMMARY

According to the present disclosure a coil for a transformer assembly is provided. The coil extends circumferentially around a longitudinal axis. The coil comprises a foil winding arrangement and a conductor element. The foil winding arrangement extends circumferentially around the longitudinal axis and has four edge regions. The conductor element covers at least partially at least one of the edge regions of the foil winding arrangement.

The conductor element allows for a reduction in an electric field that arises during an operation of the transformer assembly at the edges of the foil winding arrangement. In this manner, a performance improvement in partial discharge tests and lightning impulse tests can be achieved. Moreover, in case a solid insulation is used between a low voltage winding and a high voltage winding, the achieved reduction in the dielectric stress allows for an improvement in the performance of the dielectric ageing. Thus, it can be overall achieved that clearance distances can be reduced.

Various embodiments may implement the following features:

The conductor element may be arranged and designed to electrically shield or screen the foil winding arrangement. The conductor element may extend cylindrically around the longitudinal axis, particularly in a closed ring-shaped manner.

The coil may further comprise an insulation element, for example made of epoxy resin, surrounding both, the foil winding arrangement and the conductor element. The insulation element may surround the foil winding arrangement and/or the conductor element completely.

The transformer assembly may be a dry-type transformer assembly.

The conductor element may cover the at least one of the edge regions completely. This further improves the reduction of the electric field.

The coil may have an extension H along the longitudinal axis, and the foil winding arrangement has an extension h along the longitudinal axis, wherein the extension h of the foil winding arrangement is at least 75% of the extension H of the coil. For example, the extension h of the foil winding arrangement is at least 80% or at least 85% of the extension H of the coil. For example, the foil winding arrangement may be the only foil winding arrangement of the coil.

Alternatively, the coil may have an extension H along the longitudinal axis, and the foil winding arrangement has an extension h′ along the longitudinal axis, wherein the extension h′ of the foil winding arrangement is less than 50% of the extension H of the coil, such as less than 30% of the extension H of the coil. For example, the extension h′ of the foil winding arrangement is less than 20% or less than 10% of the extension H of the coil. For example, the foil winding may form a so-called foil disk. The coil may comprise a plurality of foil disks. The foil disks may be connected to each other electrically.

The foil winding arrangement may have, with respect to the longitudinal axis, a first end face, a second end face, a radially inward facing surface, and a radially outward facing surface, wherein the first end face and the radially inward facing surface are connected via a first edge region of the four edge regions, wherein the second end face and the radially inward facing surface are connected via a second edge region of the four edge regions, wherein the first end face and the radially outward facing surface are connected via a third edge region of the four edge regions, and wherein the second end face and the radially outward facing surface are connected via a fourth edge region of the four edge regions. In this manner, the reduction of the electric filed by the conductor element is particularly effective.

The foil winding arrangement may comprise a conductor member and an insulating member, wherein the radially inward facing surface and/or the radially outward facing surface is at least partially formed by the conductor member. The conductor element contacts the radially inward facing surface or the radially outward facing surface of the foil winding arrangement directly. In this way, the conductor element allows for a particularly effective shielding or screening.

The conductor element may cover the first edge region and the second edge region. Additionally or alternatively, the conductor element may cover the third edge region and the fourth edge region.

The conductor element may be a one-piece element, particularly, a one-piece element made of metal, for example made of aluminum.

The conductor element may be a bent metal foil element. The metal foil element has a thickness between 0.1 mm and 0.5 mm, such as between 0.2 mm and 0.4 mm.

The conductor element may have a curled edge region, wherein the conductor element covers the at least one edge region of the foil winding arrangement at least partially, and/or completely by the curled edge region.

According to another aspect of the disclosure, a transformer assembly is provided that comprises a coil as described herein.

According to a further aspect of the disclosure, a conductor element for covering at least partially at least one of four edge regions of a foil winding arrangement of a coil for a transformer assembly is provided. The conductor element is a bent metal foil element comprising a curled-edge region.

According to a further aspect of the disclosure, a method of producing the conductor element is provided. The method comprises the following step: pushing or drawing a metal foil element through a shaping tool in order to form the curled edge region of the conductor element.

### BRIEF DESCRIPTION OF THE DRAWINGS

The subject-matter of the disclosure will be explained in more detail with reference to exemplary embodiments which are illustrated in the attached drawings, in which:

FIG. 1 is a schematic frontal view of a transformer assembly comprising limbs and yokes, wherein a coil is illustrated exemplarily wound around one of the limbs.

FIG. 2 is a schematic perspective view of a coil having a section of the coil cut away for showing a partial cross section of the coil.

FIG. 3a is a schematic cross-sectional view of a coil according to an embodiment of the disclosure, wherein the coil comprises three foil winding arrangements, forming three foil disks.

FIG. 3b is a schematic cross-sectional view of a coil according to a further embodiment of the disclosure, wherein the coil comprises solely one foil winding arrangement.

FIG. 4 is a schematic detail view of an edge region of a foil winding arrangement and a conductor element.

FIG. 5a shows a shaping tool for producing a conductor element according to the disclosure, showing a profiled through-hole.

FIGS. 5b and 5c show two different perspectives of a metal foil element extending with a conically shaped front end portion through the through hole of the shaping tool.

FIG. 5d shows the conductor element produced by using the shaping tool.

### DETAILED DESCRIPTION

Example embodiments of the disclosure will be described with reference to the drawings in which identical or similar reference signs designate identical or similar elements. The features of embodiments may be combined with each other, unless specifically noted otherwise.

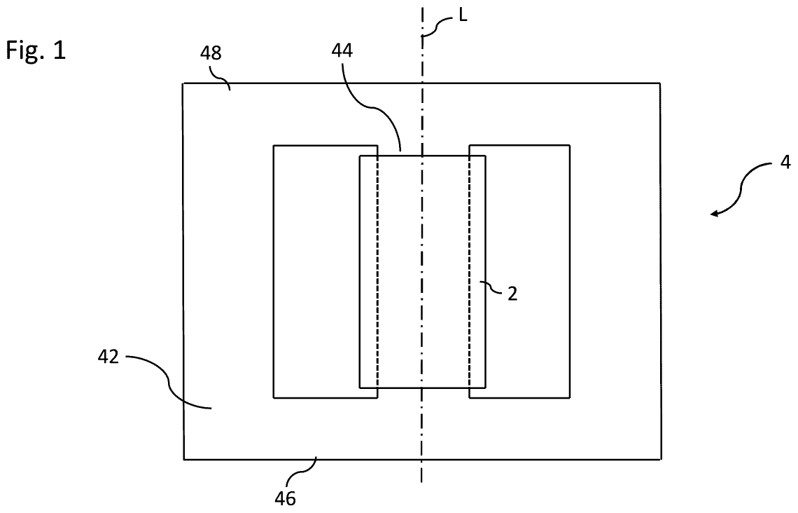

FIG. 1 is a schematic front view of a transformer assembly 4 according to the disclosure. The transformer assembly 4 may be a dry-type transformer assembly. The transformer assembly 4 comprises a core 42 having a column or limb 44 that extends between a first or lower yoke 46 and a second or upper yoke 48. The limb 44 extends along a longitudinal axis L.

A coil 2 according to the disclosure is wound around the limb 44. Thus, the coil 2 extends circumferentially around the longitudinal axis L.

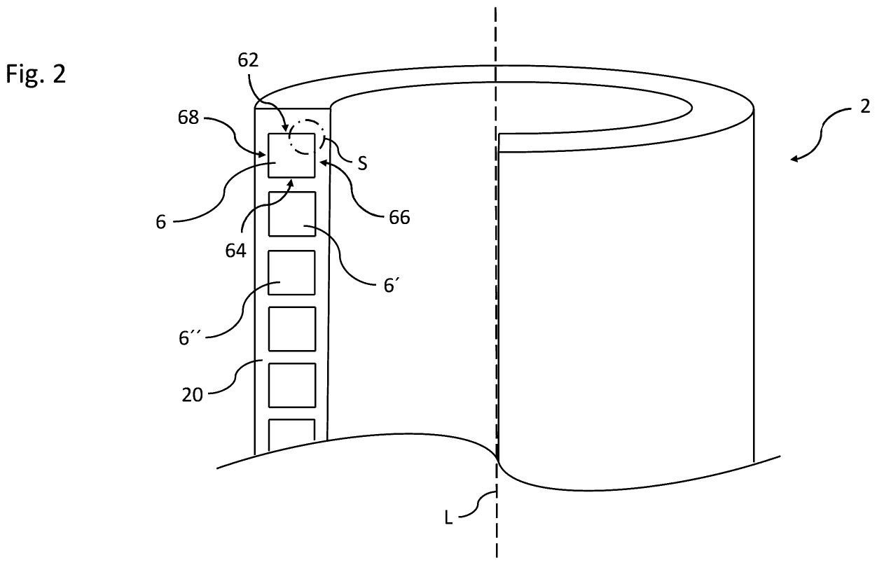

FIG. 2 is a schematic perspective view of the coil 2 having a section of the coil 2 cut away for showing a partial cross section of the coil 2.

The coil 2 comprises a foil winding arrangement 6 that extends circumferentially around the longitudinal axis L. The foil winding arrangement 6 comprises several turns of a foil wound around the longitudinal axis L.

The coil 2 may also comprise at least one further foil winding arrangement 6′, 6″, where the foil winding arrangements 6, 6′, 6″ are arranged along the longitudinal axis L, forming so-called foil disks. The foil disks may be electrically connected to each other.

The foil winding arrangement 6 has, with respect to the longitudinal axis L, a first end face 62. The first end face 62 may extend at least substantially within a plane perpendicular to the longitudinal axis L. The first end face 62 may be substantially annulus-shaped. In other words, the first end face 62 may be bordered by a radially inner border line and a radially outer border line. The radially inner border line and the radially outer border line particularly extend around the longitudinal axis L, in particular at least substantially circular.

Further, the foil winding arrangement 6 has a second end face 64. The second end face 64 may extend at least substantially within a further plane perpendicular to the longitudinal axis L. The second end face 62 may be as well substantially annulus-shaped. In other words, the second end face 62 may be bordered as well by a radially inner border line and a radially outer border line. The radially inner border line and the radially outer border line particularly extend around the longitudinal axis L, in particular at least substantially circular.

Further, the foil winding arrangement 6 has a radially inward facing surface 66. The radially inward facing surface 66 extends between the first end face 62 and the second end face 64. The radially inward facing surface 66 is at least substantially shaped cylindrical with respect to the longitudinal axis L.

Further, the foil winding arrangement 6 has a radially outward facing surface 68. The radially outward facing surface 68 extends between the first end face 62 and the second end face 64. The radially outward facing surface 68 is at least substantially shaped cylindrical with respect to the longitudinal axis L, having a larger radius than the cylindrical shape of the radially inward facing surface 66.

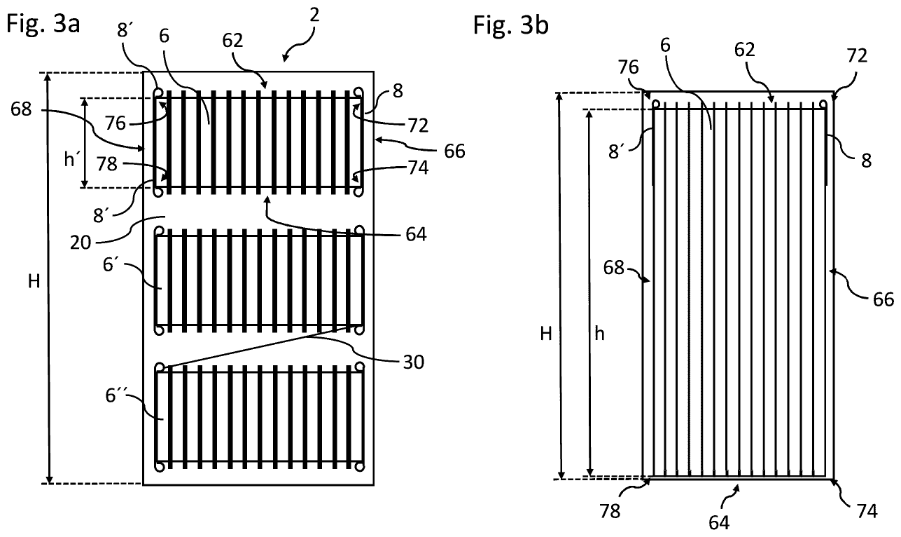

FIG. 3a is a schematic cross-sectional view of a coil 2 according to the disclosure. The foil winding arrangement 6 shows four edge regions 72, 74, 76, and 78.

The first end face 62 and the radially inward facing surface 66 are connected via a first edge region 72 of the four edge regions 72, 74, 76, 78. In other words, the first edge region 72 is formed by the radially inner border line of the first end face 62.

The second end face 64 and the radially inward facing surface 66 are connected via a second edge region 74 of the four edge regions 72, 74, 76, 78. In other words, the second edge region 74 is formed by the radially inner border line of the second end face 64.

The first end face 62 and the radially outward facing surface 68 are connected via a third edge region 76 of the four edge regions 72, 74, 76, 78. In other words, the third edge region 76 is formed by the radially outer border line of the first end face 62.

The second end face 64 and the radially outward facing surface 68 are connected via a fourth edge region 78 of the four edge regions 72, 74, 76, 78. In other words, the fourth edge region 78 is formed by the radially outer border line of the second end face 64.

The coil 2 further comprises an insulation element 20, for example made of epoxy resin, surrounding the foil winding arrangement. The insulation element 20 may at least substantially define an outer shape of the coil 2.

A conductor element 8 covers at least partially at least one of the edge regions 72, 74, 76, 78 of the foil winding arrangement 6. As can be seen in FIG. 3a, the conductor element 8 may for example cover the first edge region 72 and the second edge region 74 of the foil winding arrangement 6. A further conductor element 8′ may cover the third edge region 76 and the fourth edge region 78 correspondingly. The conductor element 8 may be surrounded, e.g., completely surrounded together with the foil winding arrangement 6 by the insulation element 20. In other words, the conductor element may be completely embedded within the insulation element 20.

FIG. 3b is a schematic cross-sectional view of a coil 2 according to a further embodiment, wherein the coil 2 comprises merely one foil winding arrangement 6. Here, the conductor element 8 solely covers the first edge region 72 of the foil winding arrangement 6. A further conductor element 8′ may be provided covering the third edge region 76. Further conductor elements (not shown in FIG. 3b) may be provided correspondingly covering the second edge region 74, and the fourth edge region 78, respectively.

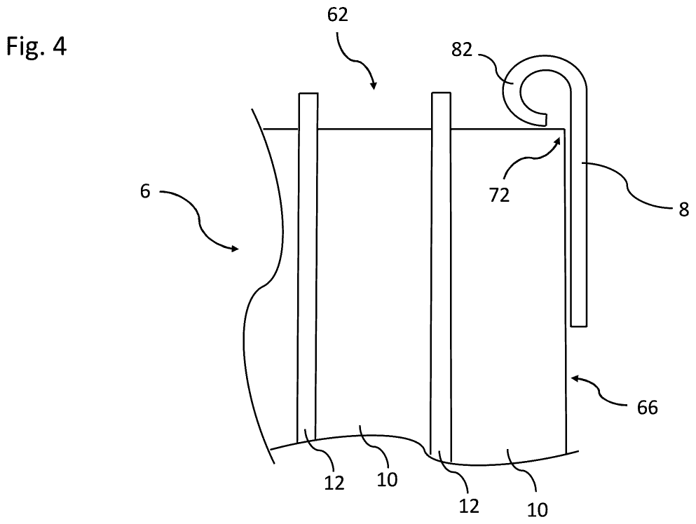

FIG. 4 is a schematic detail view of the first edge region 72 being covered by the conductor element 8. As further illustrated in FIG. 4, the foil winding arrangement 6 may comprise a conductor member 10 and an insulating member 12. The conductor member 10 may be the foil wound in several turns around the longitudinal axis L. The insulating member 12 my form an “interturn isolation” arranged radially between the turns of the foil or conductor member 10. The radially inward facing surface 66 and/or the radially outward facing surface 68 may be at least partially formed by the conductor member 10.

As illustrated in FIG. 3a, the conductor member of one foil disk 6′ may be connected to the conductor member of another foil disk 6″ by a conductor member section 30 connecting, e.g., the radially inner end of the one foil disk 6′ with the radially outer end of the other foil disk 6′.

The conductor element 8 may contact the radially inward facing surface 66 or the radially outward facing surface 68 of the foil winding arrangement 6 directly.

The conductor element 8 may be a one-piece element or an integral element. The conductor element 8 may be made of metal, for example made of aluminum. The conductor element 8 may be a bent metal foil element. The metal foil element may have a thickness between 0.1 mm and 0.5 mm, in particular between 0.2 mm and 0.4 mm.

As can be seen, e.g., in FIG. 4, the conductor element 8 may have a curled edge region 82, wherein the conductor element 8 covers the at least one edge region 72, 74, 76, 78 of the foil winding arrangement 6 at least partially, in particular completely by the curled edge region 82. As illustrated in FIG. 3a, the conductor element 8 may further comprise a further curled edge region for covering at least one further edge region of the foil winding arrangement.

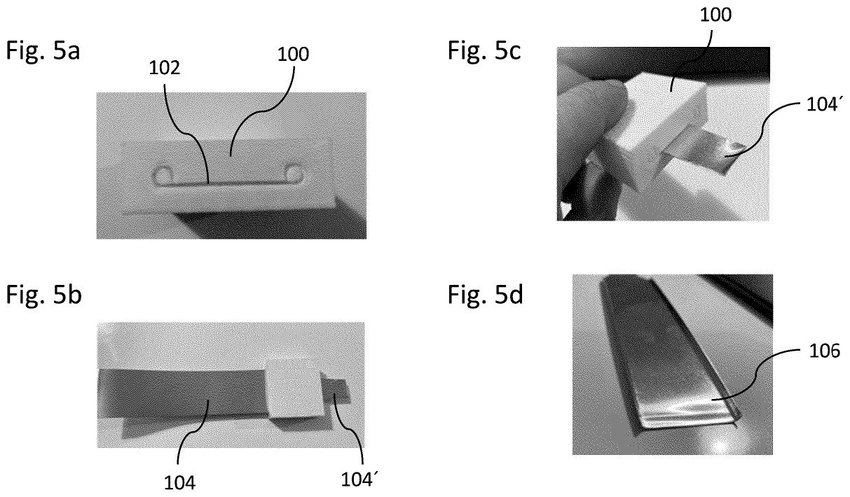

FIG. 5a shows a shaping tool 100 for producing a conductor element 8 according to the disclosure, showing a profiled through-hole 102. the profiled through hole 102 conforms to the final cross-section of the conductor element 8. The shaping tool 100 may be for example a three-dimensional printed object.

FIGS. 5b and 5c show two different perspectives of a metal foil element 104 extending with a conically shaped front end portion—or a front end portion 104′ having a reduced width—through the profiled through hole 102 of the shaping tool 100. By pushing and/or pulling the metal foil element 104 completely through the through hole 102, a curled edge region—or as shown in Figures a to 5d two curled edge regions—can easily be formed. FIG. 5d shows the metal foil element 106 after being pushed through the shaping tool 100. The so shaped metal foil element 108 forms the conductor element 8.

As exemplarily illustrated, the profiled through hole 102 of the shaping tool 100 is shaped for producing two curled edge regions. A shaping tool for shaping a conductor element comprising solely one curled region may be provided correspondingly.

While the disclosure has been described in detail in the drawings and forgoing description, such description is to be considered illustrative or exemplary and not restrictive. Variations to the disclosed embodiments can be understood and effected by those skilled in the art and practicing the disclosed embodiments, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A coil for a transformer assembly, the coil extending circumferentially around a longitudinal axis, and comprising a foil winding arrangement, extending circumferentially around the longitudinal axis and having four edge regions, and
a conductor element that covers at least partially at least one of the edge regions of the foil winding arrangement,
wherein the conductor element is a one-piece element which extends cylindrically around the longitudinal axis in a closed ring-shaped manner.

2. The coil of claim 1, wherein the conductor element covers the at least one of the edge regions completely.

3. The coil of claim 1, wherein the coil has an extension along the longitudinal axis, and the foil winding arrangement has an extension along the longitudinal axis, wherein the extension of the foil winding arrangement is at least 75% of the extension of the coil.

4. The coil of claim 1, wherein the coil has an extension along the longitudinal axis, and the foil winding arrangement has an extension along the longitudinal axis, wherein the extension of the foil winding arrangement is less than 50% of the extension of the coil, preferably less than 30% of the extension H of the coil.

5. The coil of claim 1, wherein the foil winding arrangement has, with respect to the longitudinal axis, a first end face, a second end face, a radially inward facing surface, and a radially outward facing surface,
wherein the first end face and the radially inward facing surface are connected via a first edge region of the four edge regions,
wherein the second end face and the radially inward facing surface are connected via a second edge region of the four edge regions,
wherein the first end face and the radially outward facing surface are connected via a third edge region of the four edge regions, and
wherein the second end face and the radially outward facing surface are connected via a fourth edge region of the four edge regions.

6. The coil of claim 5, wherein the foil winding arrangement comprises a conductor member and an insulating member, wherein the radially inward facing surface and/or the radially outward facing surface is at least partially formed by the conductor member.

7. The coil of claim 5, wherein the conductor element contacts the radially inward facing surface or the radially outward facing surface of the foil winding arrangement directly.

8. The coil of claim 5,
wherein the conductor element covers the first edge region and the second edge region, or
wherein the conductor element covers the third edge region and the fourth edge region.

9. The coil of claim 1, wherein the conductor element is made of metal.

10. The coil of claim 1, wherein the conductor element is a bent metal foil element.

11. The coil of claim 1, wherein the conductor element has a curled edge region, wherein the conductor element covers the at least one edge region of the foil winding arrangement at least partially; preferably completely by the curled edge region.

12. A transformer assembly, comprising the coil of claim 1.

13. A conductor element for covering at least partially at least one of four edge regions of a foil winding arrangement of a coil for a transformer assembly, wherein the coil extends circumferentially around a longitudinal axis, wherein the conductor element is a bent metal foil element comprising a curled-edge region,
wherein the conductor element is a one-piece element configured to extend cylindrically around the longitudinal axis in a closed ring-shaped manner.

14. Method of producing a conductor element for covering at least partially at least one of four edge regions of a foil winding arrangement of a coil for a transformer assembly, wherein the conductor element is a bent metal foil element comprising a curled-edge region, comprising the following step
pushing or drawing a metal foil element through a shaping tool in order to form the curled edge region of the conductor element.

15. The coil of claim 4, wherein the extension of the foil winding arrangement is less than 30% of the extension of the coil.

16. The coil of claim 1, wherein the conductor element is made of aluminum.

17. The coil of claim 10, wherein the metal foil element has a thickness between 0.1 mm and 0.5 mm.

18. The coil of claim 10, wherein the metal foil element has a thickness between 0.2 mm and 0.4 mm.

19. The coil of claim 11, wherein the conductor element covers the at least one edge region of the foil winding arrangement completely by the curled edge region.

20. The conductor element of claim 13, wherein the conductor element is configured to cover the at least one of the edge regions completely.
